(19) United States
(12) Patent Application Publication
(10) Pub. No.: US 2004/0210617 A1
(43) Pub. Date: Oct. 21, 2004

(54) Sampling methods, reconstruction methods and devices for sampling and/or reconstructing multidimensional signals

(76) Inventors: Martin Vetterli, Grandvaux (CH); Irena Maravic, Lausanne (CH); Pierluigi Dragotti, London (GB)

Correspondence Address: Peter A. Businger, Esq., 344 Valleyscent Avenue, Scotch Plains, NJ, 07076-1170, US

(21) Appl. No.: 10/832,423

(22) Filed: Apr. 23, 2004

Related U.S. Application Data
(63) Continuation of application No. PCT/EP02/11862, filed on Oct. 23, 2002.

(30) Foreign Application Priority Data
Oct. 23, 2001 (EP) 01125180.8

(51) Int. Cl. G06G 7/12

(52) U.S. Cl. 708/814

(57) ABSTRACT

Reconstruction method and devices for two-dimensional signals that are not bandlimited but have a parametric representation with a finite number of degrees of freedom. The signal is reconstructed from the samples obtained after a suitable filtering with a smoothing kernel. Projection techniques allow reducing the problem to a combination of one-dimensional subproblems.

Sampling methods, reconstruction methods and devices for sampling and/or reconstructing multidimensional signals Sampling theory has experienced a strong research revival over the past decade, which led to refinement of original Shannon's theory and development of more advanced formulations with direct impact in signal processing and communications. For example, the traditional sampling paradigm for representation of bandlimited functions can be extended to classes of signals, such as splines, that are not bandlimited but live on a subspace spanned by a generating function and its shifts.

International Patent Application WO 02/078197, in the name of the applicant and which is hereby incorporated by reference, develops sampling schemes for a larger class of non-bandlimited signals, such as stream of Diracs, non-uniform splines and piecewise polynomials. A common feature of these signals is that they have a parametric representation with a finite number of degrees of freedom, and can be perfectly reconstructed from a finite set of samples.

On the other hand, while there are many interesting results for one-dimensional signals, the problem becomes more involved when going to higher dimensions. Furthermore, most of the multidimensional sampling algorithms encountered in practice still rely on results from a bandlimited case, which may lead to unnecessarily high computational load, particularly for those classes of signals that could presumably be represented by a finite number of samples. Therefore, a very interesting but challenging question is whether it is possible to come up with practical methods for sampling multidimensional signals having finite complexity, which would allow for perfect reconstruction from a finite set of samples.

One aim of the present invention is to provide sampling and reconstruction methods for multidimensional signals that overcome the limitations of the prior art.

Another aim of the present invention is to provide sampling and reconstruction methods for multidimensional signals that decompose the problem into a number of one-dimensional subproblems.

Another aim of the present invention is to provide sampling and reconstruction methods and devices for determining exactly the direction and the position of details in a set of images, or for determining exactly the position of photo cameras from the images taken therefrom.

The above aims are attained by the object of the appended claims.

Various embodiment of the sampling and reconstruction method of the invention applied to different classes of bidimensional signals with finite rate of innovation are explained in the specification. The one skilled in the art will understand however that the invention is not limited to the specific examples given, and that the advantageous technical effects can be obtained by sampling and reconstructing other kinds of signals with a finite rate of innovation.

The invention will be better understood with the help of the figures in which:

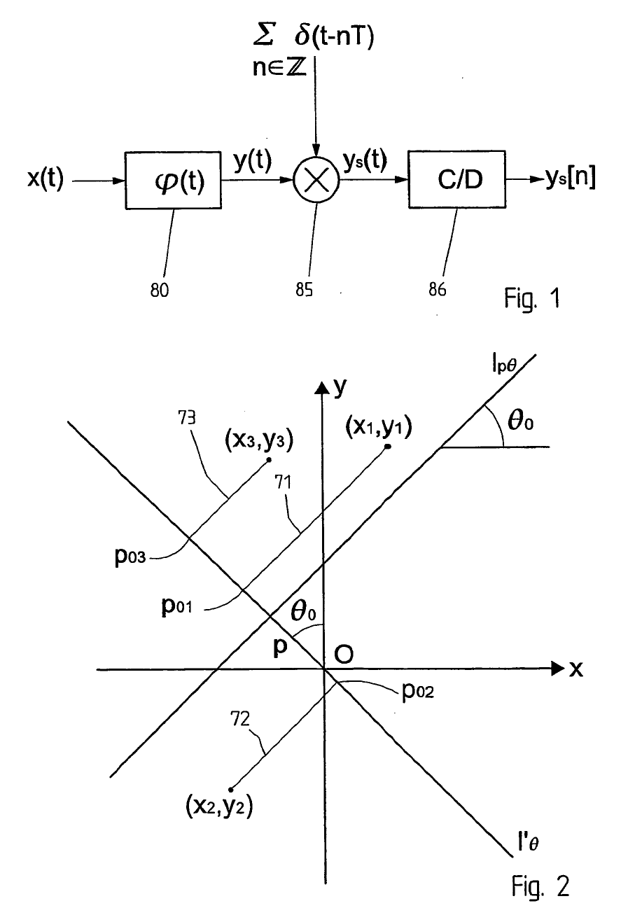

FIG. 1 diagrammatically illustrates a device and method of smoothing and sampling a signal;

FIG. 2 represents the projection of some represents the projection of the set of three Diracs onto one line according to one aspect of the invention

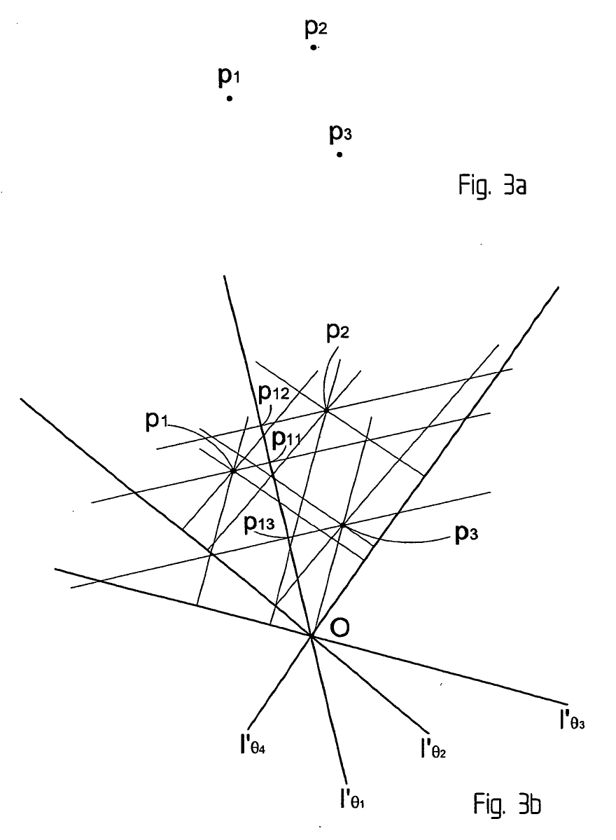

FIGS. 3a and 3b represents the set of projecting lines along four different directions, obtained from the samples. Points where exactly four projecting lines intersect correspond to the Diracs in the set;

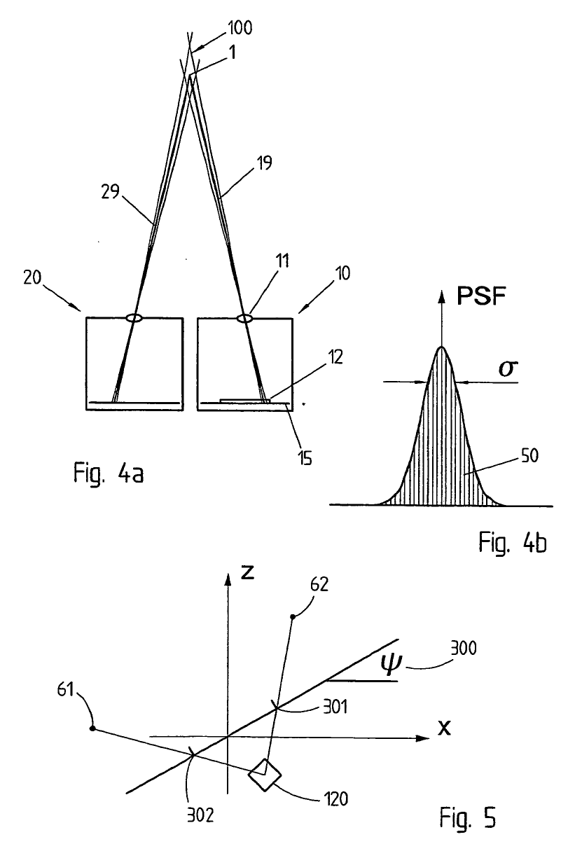

FIGS. 4a and 4b refer to an embodiment of the invention concerning the reconstruction of the position of a point from a set of images

FIG. 5 refers to a further embodiment of the invention;

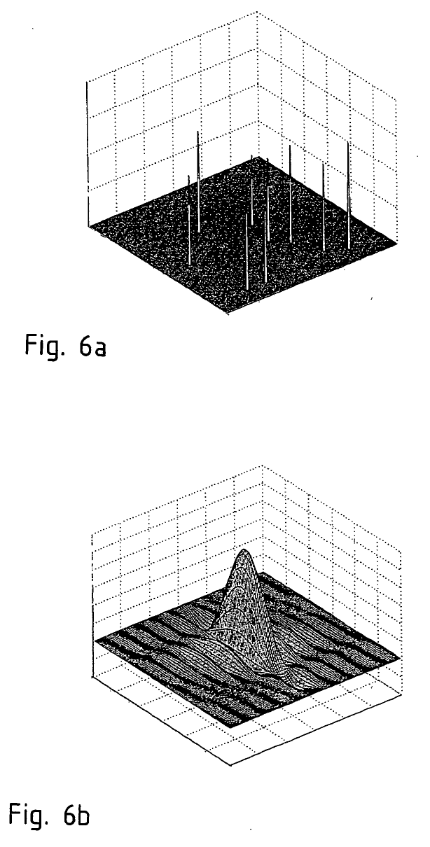

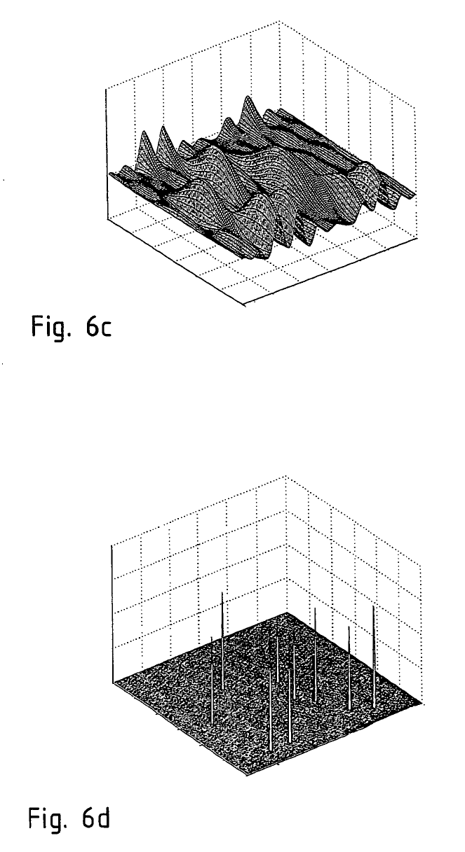

FIG. 6a represents a signal made up of 17 weighted Diracs;

FIG. 6b represents a 2-D sinc smoothing kernel;

FIG. 6c represents an approximation obtained by convolving the signal of FIG. 6a with the kernel of FIG. 6b;

FIG. 6d represents the signal reconstructed according to one aspect of the invention.

In a first embodiment of the present invention, we exploit the properties of, for example, the Radon transform of multi-dimensional signals, and show that by taking a finite number of “filtered” line integrals, the problem can be reduced to its one-dimensional equivalent, which is much more convenient for algorithmic implementation.

The International Patent Application WO 02/078197 defines the concept of rate of innovation of a signal, and describes sampling and reconstruction schemes for signals that are not bandlimited, but exhibit a finite rate of innovation or a locally finite rate of innovation.

The rate of innovation of a one-dimensional signal is defined as the number of degrees of freedom of the signal within a time period. For example a periodic Poisson process signal made of K weighted Dirac pulses δ(t) and having period τ, can be fully specified by the K occurrence times or shifts tₖ and the K amplitudes or weights cₖ of the Diracs. The signal can be written as

$$x ( t ) = {\sum }_{n}^{} {\sum }_{k = 0}^{K - 1} {c}_{k} δ ( t - ( {t}_{k} + n τ ) ) \qquad ( 1 )$$

wherein the degree of freedom of this signal is obviously 2K. Its rate of innovation is thus finite and equal to 2K/τ.

On the other hand the signal (1) is not band-limited. Therefore, according to the classic sampling theorem of Whittaker, Kotelnikov and Shannon, it can not be faithfully reconstructed by a finite number of its samples. The International Patent Application WO 02/078197 teaches how to reconstruct exactly non-bandlimited signals from a finite number of samples y[n] of a smoothed signal y(t), obtained by convolution with a suitable smoothing kernel φ. The process is shown on FIG. 1.

The main purpose for introducing the rate of innovation p, is that it can be directly related to the minimum sampling rate, or the minimum number of samples that can lead to perfect reconstruction.

The Continuous-time Fourier series (CTFS) coefficients of x(t) are defined by

$$X [ m ] = \frac{1}{τ} {\sum }^{} {c}_{k} {ⅇ}^{- ⅈ 2 π {t}_{k} m / τ} \qquad ( 2 )$$

If the signal x(t) is convolved with a sinc smoothing kernel of bandwidth [−K/τ, K/τ] then we obtain the lowpass approximation y(t) given by

$$y ( t ) = {\sum }_{m = - K}^{K} X [ m ] {ⅇ}^{ⅈ 2 π t m / t} \qquad ( 3 )$$

Suppose that the lowpass approximation y(t) is sampled at multiples of T, we obtain τ/T discrete samples defined by

$${y}_{s} [ l ] = y ( lT ) = {\sum }_{m = - K}^{K} X [ m ] {ⅇ}^{ⅈ 2 π m lT / τ} l = 0 , … τ / T - 1 \qquad ( 4 )$$

as long as the number of samples is larger than the number of values in the spectral support of the lowpass signal y(t), that is τ/T≧2K+1, the values of the 2K+1 central values of X[m] coefficients is determined by relation (4). The X[m] can be obtained by applying the Fourier transform to the samples yₛ[l] of the filtered signal, in a well known way.

The locations and weights of all the Diracs in (2) can be completely determined by 2K+1 CTFS coefficients X[m]. From (2) we have that the CTFS coefficients X[m] are linear combinations of K complex exponentials.

$${u}_{k}^{m} = exp ( - 1 \frac{2 π {mt}_{k}}{τ} ) with weights \frac{1}{τ} {c}_{k} \qquad ( 5 )$$

Thus to find the locations tk we may for example proceed by finding the annihilating filter H(z) with coefficients 1, H[1], H[2], . . . H[K] defined as

H(z)=1+H[1]z⁻¹+H[2]z⁻²+ . . . +H[k]z^{-k} (6)

which satisfies

$${\sum }_{k = 0}^{K} H [ k ] X [ m - k ] = 0 m = 1 , … K \qquad ( 7 )$$

It can be shown that the k shifts tₖ of the Dirac are given by, or at least can be retrieved from the zeros of H(z).

The filter H(z) can be found by solving the following structured linear equation system:

$$[ \begin{matrix}X [ 0 ] & X [ - 1 ] & ⋯ & X [ - K - 1 ] \\ X [ 1 ] & X [ 0 ] & & X [ - K - 2 ] \\ ⋮ & & & ⋮ \\ X [ K - 1 ] & X [ K - 2 ] & ⋯ & X [ 0 ]\end{matrix} ] \cdot [ \begin{matrix}H [ 1 ] \\ H [ 2 ] \\ ⋮ \\ H [ K ]\end{matrix} ] = - [ \begin{matrix}X [ 1 ] \\ X [ 2 ] \\ ⋮ \\ X [ K ]\end{matrix} ] \qquad ( 8 )$$

Because the matrix is a Toeplitz system, fast algorithms are available for finding the solution. This system has an unique solution if the matrix is invertible, which is the case if all K Diracs in x(t) are distinct.

Given the coefficients H, the filter H(z) can be factored into its roots

$$H ( z ) = {\prod }_{k = 0}^{K - 1} ( 1 - {u}_{k} {z}^{- 1} ) \qquad ( 9 )$$

which leads to the shifts tₖ using the above relation between uₖ and tₖ.

Given the shifts tₖ the K values can be found by solving

$$X [ m ] = \frac{1}{τ} {\sum }_{k = 0}^{K - 1} {c}_{k} {ⅇ}^{- ⅈ \frac{π m {t}_{k}}{τ}} \qquad ( 10 )$$

which leads to the following Vandermonde system

$$[ \begin{matrix}X [ 0 ] \\ X [ 1 ] \\ ⋮ \\ X [ K - 1 ]\end{matrix} ] = \frac{1}{τ} [ \begin{matrix}1 & 1 & ⋯ & 1 \\ {u}_{0} & {u}_{1} & ⋯ & {u}_{K - 1} \\ & & & ⋮ \\ {u}_{0}^{K - 1} & {u}_{1}^{K - 1} & ⋯ & {u}_{K - 1}^{K - 1}\end{matrix} ] \cdot [ \begin{matrix}{c}_{0} \\ {c}_{1} \\ ⋮ \\ {c}_{K - 1}\end{matrix} ] \qquad ( 11 )$$

which can be solved in a known way.

Similar reconstruction methods are possible for other classes of functions having a finite rate of innovation, namely bilevel signals, splines, polynomial signals, piecewise linear signals, piecewise polynomial signals and approximations thereof. Moreover the smoothing kernel can be other than a sinc function, for example a Gaussian function, a spline function, a box function or a hat function, as it is known from PCT/EP02/03380.

The rate of innovation of a multi-dimensional signal can be defined in a perfectly analogous fashion. Consider for example a two-dimensional bandlimited signal g(x,y), with the Fourier transform that is nonzero over a finite region R in the frequency space (fₓ,f_{y}). If we let 2Bₓ and 2B_{y} represent the widths in the fₓ and f_{y} directions of the smallest rectangle that encloses the region R, According to the sampling theorem of Whittaker, Kotelnikov and Shannon, the signal can be perfectly represented by the uniformly spaced samples cₘᵢₙ via convolution with the sinc kernel.

$$g ( x , y ) = {\sum }_{m = - ∞}^{+ ∞} {\sum }_{n = - ∞}^{+ ∞} {c}_{m n} \frac{sin ( π ( x - m X ) / X ) \cdot sin ( π ( y - n Y ) / Y )}{π ( x - m X ) / X \cdot π ( y - n Y ) / Y} \qquad ( 12 )$$

where X and Y are such that X≦1/2Bₓ and Y≦1/2B_{y}, and gₘᵢₙ=g(mX, nY).

The above result can be interpreted in the following way. The bandlimited signal g(x,y) can be considered as having 1/X and 1/Y degrees of freedom per unit of length in x andy directions respectively, which we call the rates of innovation ρₓ and ρ_{y}. The total rate of innovation of the signal is then defined as the sum of the rates of innovation for each independent variable ρ=ρₓ+ρ_{y}.

A more general form of the above expression for g(x,y), which extends the subspace of bandlimited functions, is obtained by replacing the function sinc(x,y) by a more general template, the so-called generating function φ(x,y).

$$g ( x , y ) = {\sum }_{m = - ∞}^{+ ∞} {\sum }_{n = - ∞}^{+ ∞} {c}_{m n} ϕ ( \frac{x - {x}_{m}}{X} , \frac{y - {y}_{n}}{Y} ) \qquad ( 13 )$$

xₘ and yₙ being arbitrary shifts. Clearly this substitution does not alter the rate of innovation ρ of g(x,y). When φ(x,y)=δ(x,y) and both xₙ−xₙ₋₁ and yₙ−yₙ₋₁ are i.i.d random variables with exponential density, then g(x,y) describes a 2-D Poisson process. Examples of other classes include simple lines and polygonal lines, planar parametric curves, as well as bi-level signals whose boundaries have a finite number of degrees of freedom.

We will continue the analysis by considering a signal g(x,y) that is made up of M Diracs generated by a 2-D Poisson process, which has a simple parametric representation, but whose algebraic structure provides a good insight into the fundamental principles inherent in algorithms for more complicated signals. The concept we present is based on sampling the Radon transform of the signal g(x,y), and offers a possibility of decomposing the problem into a set of 1-D equivalents.

Let the signal g(x,y) be represented as

$$g ( x , y ) = {\sum }_{k = 0}^{K - 1} {c}_{k} δ ( x - {x}_{k} , y - {y}_{k} ) \qquad ( 14 )$$

and let R_{g}(p,θ) be the Radon transform of g(x,y), defined by

R_{g}(p,θ)=∫g(x,y)δ(p−x·cos(θ)−y·sin(θ)) dxdy (15)

On FIG. 2 a two-dimensional signal g(x,y) composed of three Dirac pulses is represented on a xy plane. The Diracs are at the positions (x₁,y₁), (x₂,y₂), (x₃,y₃). For given angle θ₀ and distance p from the origin, the Radon transform operation R_{g}(p,θ₀) is given by the integral of g(x,y) along the line l_{p,θ} defined by p=x·cos(θ)+y·sin(θ), crossing the axis x at an angle θ₀ and distant p from the origin O.

For any given angle θ₀, the Radon transform R_{g}(p, θ₀) can be interpreted graphically as the one-dimensional projection of the function g(x,y) onto the line l′_{θ} passing from the origin and orthogonal to the line l_{p,θ} a as it is visible on FIG. 2.

In the case above, the Radon transform R_{g}(p,θ₀) of the signal g(x,y) composed of three Dirac pulses will be also composed of three Dirac pulses, located at the points p₀₁, p₀₂, p₀₃, corresponding to the projections of the 2-dimensional Diracs at (x₁,y₁), (x₂,y₂), (x₃,y₃), along the projection lines 71, 72, 73 respectively, on the line l′_{θ}.

The Radon transform R_{g}(p,θ₀) possess therefore a finite rate of innovation, and can be represented as a one-dimensional weighted sum of M₀ Diracs

$${R}_{g} ( p , {θ}_{0} ) = {\sum }_{k = 0}^{{M}_{0} - 1} {a}_{0 k} δ ( p - {p}_{0 k} ) \qquad ( 16 )$$

In the general case, for almost every value of θ₀, each Dirac will project a distinct counterpart on the line l′_{θ}, thus M₀=M almost always. For some particular choice of θ₀, however, there will be more than one Dirac spike on the path of integration, therefore in general M₀≧M holds.

This fact is exploited in this embodiment of the invention to tackle the problem in the 2-D case. Since the signal consisting of M 1-D Diracs can be perfectly recovered from a set of 2M samples, as it is known from the above mentioned International Patent Application WO 02/078197, by using either the sinc or the Gaussian sampling kernel, we can take advantage of that result and develop a sampling scheme for 2-D signals as well. Namely, instead of taking the line integral in the equation (4), we can replace the δ-function with the appropriate kernel, such as the sinc function. In other words, we can consider the filtered projection of the signal g(x,y)

$${\overline{R}}_{g} ( p , θ ) = \int g ( x , y ) {B}_{p} \frac{sin ( π {B}_{p} ( p - {p}_{θ} ) )}{π {B}_{p} ( p - {p}_{θ} )} ⅆ x ⅆ y \qquad ( 17 )$$

where p_{δ}=x·cos(θ)+y·sin(θ). An interesting property emerging form this formulation is that for any angle θ₀, the projection of g(x,y) becomes a convolution of its Radon transform R_{g}(p,θ₀), which represents a 1-D stream of Diracs, and the sine sampling kernel, i.e.

$${\overline{R}}_{g} ( p , θ ) = {R}_{g} ( p , {θ}_{0} ) * {B}_{p} \frac{sin ( π {B}_{p} p )}{π {B}_{p} p} \qquad ( 18 )$$

The above equation implies, by virtue of the method disclosed in International Patent Application WO 02/078197, that the locationspk and weights aₖ of the 1-D Diracs, defined by (16), can be obtained from N≧2M₀ samples of \overline{R}_{g}(p,θ), that is,

pₙ(θ₀)=\overline{R}_{g}((p−nTₚ,θ₀) n=0,1, . . . N−1 (19)

where Tₚ=1/Bₚ.

While the set of locations p₀ₖ does not itself define g(x,y), the projection of g(x,y) onto M+1 straight lines entirely specifies the signal. Assume therefore that we do the projection of g(x,y) onto M+1 lines with different slopes, determined by angles θ₀, θ₁, . . . , θ_{M}, as shown in FIGS. 3a and 3b. By using the method described above, we can solve for the coordinates pₘₖ and weights aₘₖ, m=0,1, . . . M of the 1-D Dirac streams along each line, and thus uniquely specify the set of “projecting” lines that extend perpendicularly from each pₘₖ, as it is visible on FIG. 3b. Clearly, for any point that belongs to the set of 2-D Diracs, exactly M+1 projecting lines must intersect. A reverse statement, that the points where M+1 projecting lines intersect must belong to the set, can be proved by counterexample. Namely, assume that exactly M+1 such lines intersect at some point A. If A doesn't belong to the set of Diracs, then there must be at least one point from the set located at each of the lines lₚ_{_{—}}_{mk,θ}_{_{—}}ₘ, m=0,1, . . . M, which implies that g(x,y) is being made up of at least M+1 Diracs, and that obviously contradicts our basic assumption.

The weights cₖ can be found by solving the system of M linear equations that we can choose out of (M+1)2M equations (available from the set of projections of g(x,y)). Thus the signal g(x,y) composed of a finite set of M weighted 2-D Diracs can be perfectly reconstructed from 2M(M+1) samples of the filtered Radon transforms \overline{R}_{g}(p,θ) defined in equation (17).

As can be seen from the above derivation, in a general case the algorithm yields a unique solution by taking on the order of M² samples of the Radon transform. We will show that in some cases of more complicated signals, the algorithm's complexity remains either the same or can be even reduced, depending on the specific signal structure, with the only difference in the sampling scheme being the use of an alternative sampling kernel.

It is to be noted that in a physical set up, very often the line integral present in the Radon transform cannot be obtained or implemented exactly. In a typical application the signal g(x,y) represents an image containing sharp details or point sources. Conventional image-recording devices are not capable to capture the original signal. Rather, a smoothed version is obtained.

In a real optical system, for example, the image will always suffer degradation from optics' finite resolution or atmospheric effects. Likewise the projections obtained in an X-ray scan will be degraded because the X-rays can not be collimated in an infinitely narrow pencil beam. That is, effectively, a filtered or smoothed Radon transform is obtained.

While mathematically, the filtering and Radon transform can be interchanged, in the physical set up one can only obtain the filtered projection rather than the ideal Radon transform. In the case of the optical system cited above, one has no direct access to the original signal g(x,y), but only to the smoothed image provided by the optical system. In the case of an X-ray scan, projection and smoothing are coupled together and can not be performed independently.

The degradations induced by the physical setup can in general be modeled by an appropriate choice of the smoothing kernel; for example by a Gaussian kernel.

The reconstruction method of the present invention provides a perfect reconstruction of the original signal g(x,y) from a finite set of samples of the filtered Radon transform.

In particular, if the original signal g(x,y) represents an image, the inventions allow reconstructing a “superresolution” image whose sharpness is much superior to that provided by conventional image-recording apparatuses. It must be noted, however that the present invention is not limited to image treatment, and rather it consists of a general method or reconstructing a multidimensional signal from a set of samples.

The Radon transform has been chosen in the above example merely to illustrate a particular mode of realization of the invention. The invention however includes also those algorithms in which variations or extensions of the Radon transform, or other transformations, are used to project the multidimensional function onto an ensemble of one-dimensional functions.

The sinc kernel employed in the above method does not constitute a limitative feature of the invention, but merely an example of one out of the many kernels utilizable in the present invention, for example gaussian, splines or hat kernels could advantageously be used when fast-decaying tails or a compact support are desirable.

In a second embodiment of the present invention, we deal with another class of non bandlimited 2-D functions of finite rate of innovation, namely that of bi-level polygons.

Consider a signal g(x,y) that is a bi-level polygon uniquely defined by its vertices located at points (xⱼ,yᵢ), i.j=1 . . . M. Clearly g(x,y) has 2M degrees of freedom. If we now project g(x,y) on a straight line, as in the previous embodiment, the result will be a 1-D piecewise linear signal, we can therefore use the same approach and incorporating the sampling scheme for such 1-D signal into our algorithm, by replacing the δfunction in the Radon transform into an appropriate smoothing kernel.

A 1-D piecewise linear signal having M pieces can be uniquely represented by 2M samples <f(p), φ⁽²⁾ (p−nTₚ)> of its convolution with the second derivative sinc function, here defined as an inverse Fourier transform

$${ϕ}^{( 2 )} ( p ) = IFT \{ {( j ω )}^{2} rect ( \frac{ω}{2 π {B}_{p}} ) ) \qquad ( 20 )$$

with Bₚ=1/Tₚ. Due to the associativity of the convolution operator, the convolution f(p)* φ⁽²⁾ is equivalent to the convolution of the second derivative of the signal with the sinc kernel, f⁽²⁾ (p)*φ, thus the problem can be reduced to the one we have already analyzed, because the second derivative of a piecewise linear signal is again a stream of Dirac pulses.

In other words the sampling scheme in the 2-D case should be modified such that the δ-function in (14) is replaced by φ⁽²⁾. In that case taking at most 2M samples from each of the M+1 projections and applying the same techniques will uniquely and exactly specify the coordinates of the vertices.

In a further embodiment of the invention, a scheme is devised for sampling and reconstructing a bi-level signal with a piecewise polynomial boundary:

$$g ( x , y ) = \{ \begin{matrix}1 & x \leq p ( x ) \\ 0 & x > p ( x )\end{matrix} \qquad ( 21 )$$

where p(x) Is a piecewise polynomial having Mpieces of maximum degree R. We can directly apply the result from the 1-D case, and take the samples of the projection of g(x, y) on the x axis, by using the (R+1)th derivative sinc kernel. Since the (R+1)th derivative p^{(R+1)}(x) is a collection of at most M weighted Dirac pulses, we need to take only 2M samples in order to exactly recover the signal.

In a further embodiment of the invention, a method is devised to reconstruct a superposition of 2-D Diracs, without resorting to the projection into a number of one-dimensional subproblems.

Let g(xy) be a 2-D periodic signal of period T along both directions

$$g ( x , y ) = {\sum }_{p , q} {\sum }_{k = 0}^{M - 1} {a}_{k} δ ( x - p T - {x}_{k} , y - q T - {y}_{k} ) \qquad ( 22 )$$

The Fourier series representation of g(x,y)

$$g ( x , y ) = {\sum }_{m = - ∞}^{+ ∞} {\sum }_{n = - ∞}^{+ ∞} G [ m , n ] exp ( ⅈ m {ω}_{0} x ) exp ( ⅈ n {ω}_{0} y ) \qquad ( 23 )$$

where ω₀=2π/T and the Fourier coefficients G[m,n] are given, as it is well known, by

$$G [ m , n ] = {\sum }_{k = 0}^{M - 1} {a}_{k} exp ( - ⅈ m {ω}_{0} x ) exp ( - ⅈ n {ω}_{0} y ) \qquad ( 24 )$$

that is a linear combination of M complex exponentials. In analogy with the one-dimensional case, the knowledge of a finite number of Fourier coefficients G[m,n] uniquely determines the positions (xₖ, yₖ) and weights aₖ in (22).

This can be done operatively by applying known singular value decomposition methods and subspace methods.

To make the notation simpler (24) can be written as

$$G [ m , n ] = {\sum }_{k = 0}^{M - 1} {a}_{k} {w}_{k}^{m} {z}_{k}^{n} \qquad ( 25 )$$

ir, in matrix notation G=WAZ with W, A and Z defined as

$$W = [ \begin{matrix}1 & 1 & ⋯ & 1 \\ {w}_{1} & {w}_{2} & & {w}_{M} \\ ⋮ & & & \\ {w}_{1}^{P - 1} & {w}_{2}^{P - 1} & & {w}_{M}^{P - 1}\end{matrix} ] \qquad ( 26 )$$

A=diag(a₁,a₂, . . . ,a_{M}) (27)

$$Z = [ \begin{matrix}1 & {z}_{1} & ⋯ & {z}_{1}^{Q - 1} \\ 1 & {z}_{2} & & {z}_{2}^{Q - 1} \\ ⋮ & & & \\ 1 & {z}_{M} & & {z}_{M}^{Q - 1}\end{matrix} ] \qquad ( 28 )$$

If the projection of the sets of Diracs on both xandy directions are distinct, then rank(G)=M and the values {w₁} and {zᵢ} can be obtained from the principal left or right singular values of the matrix G, as it is well known. When there previous condition is not satisfied, the rank deficiency of G requires a different algorithm. Among the known alternatives are the MEMP algorithm (Matrix Enhancement and Matrix Pencil). The method introduces the “enhanced matrixes”, both of rank M from which the sets {w₁} and {zᵢ} can be obtained, or the ACMP algorithm (algebraic coupling of Matrix Pencils) sketched below.

Let the K(P−L)×L(N−K) enhanced matrix J be defined as

$$J = [ \begin{matrix}{G}^{( 1 , 1 )} & {G}^{( 2 , 1 )} & ⋯ & {G}^{( L , 1 )} \\ {G}^{( 1 , 2 )} & & & \\ ⋮ & & ⋰ & \\ {G}^{( 1 , K )} & ⋯ & & {G}^{( L , K )}\end{matrix} ] \qquad ( 29 )$$

where the (k,l)-th block component of J is

Jₖₗ=G^{(l,k)}=G_{l;P-L+l,kQ-K-1+k} (30)

$${G}^{( 1 , k )} = [ \begin{matrix}G [ l , k ] & ⋯ & G [ l , Q - K - 1 + k ] \\ G [ l + 1 , k ] & & G [ l + 1 , Q - K - 1 + k ] \\ ⋮ & & \\ G [ P - L - 1 + l , k ] & ⋯ & G [ P - L - 1 + l , Q - K - 1 + k ]\end{matrix} ] \qquad ( 31 )$$

The matrix J can be written as

J=W′AZ′ (32)

where W′ and Z′ are generalized Vandermonde matrixes

W′=(W_{P-L}^{T}Z_{d}W_{P-L}^{T}Z_{d}²W_{P-L}^{T} . . . Z_{d}^{K-1}W_{P-L}^{T}) (33)

Z′=(Z_{Q-K}^{T}W_{d}Z_{Q-K}^{T}W_{d}²Z_{Q-K}^{T} . . . W_{d}^{L-1}Z_{Q-K}^{T}) (34)

W_{d} and Z_{d} are M×M diagonal matrixes, W_{d}=diag{exp(iω₀xₖ)}, Z_{d}=diag{exp(iω₀yₖ)} and W_{P-L} and Z_{Q-K} are given by

$$\begin{matrix}{W}_{M - L} = [ \begin{matrix}1 & 1 & ⋯ & 1 \\ {w}_{1} & {w}_{2} & & {w}_{M} \\ ⋮ & & & \\ {w}_{1}^{P - L - 1} & {w}_{2}^{P - L - 1} & & {w}_{M}^{P - L - 1}\end{matrix} ] & ( 35 ) \\ {Z}_{N - K} = [ \begin{matrix}1 & {z}_{1} & ⋯ & {z}_{1}^{Q - K - 1} \\ 1 & {z}_{2} & & {z}_{2}^{Q - K - 1} \\ ⋮ & & & \\ 1 & {z}_{M} & & {z}_{M}^{Q - K - 1}\end{matrix} ] & ( 36 )\end{matrix}$$

Define the top-left matrix Jₜₗ obtained by omitting the last row and the last column of the block components of J, i.e.

$${J}_{tl} = \underline{{X}^{( l , k )}} \vert = {X}_{l : P - L - 2 + l , k : Q - K - 2 + k} \qquad ( 37 )$$

where (*)| denotes the operation of deleting the last column of (*), and (*) denotes the operation of deleting the last row of (*). Define in the similar way the top-right and bottom-left matrixes Jₜᵣ and J_{blt}. The outline of the ACMP algorithm is then:

Compute the singular value decomposition of Jₜₗ

Jₜₗ=USV^{H} (38)

Find Cₜᵣ, C_{tb} C_{bl} and C_{br} from

U^{H}(Jₜᵣ−μJₜₗ)V=F(Z_{d}−μI)G=Cₜᵣ−μCₜₗ (39)

U^{H}(J_{bl}−μJₜₗ)V=F(W_{d}−λI)G=Cₜᵣ−λCₜₗ (40)

Compute the eigenvalue decomposition of the matrix

Cₜₗ⁻¹(βCₜᵣ+(1−β)C_{bl})=G⁻¹TG (41)

where β is a scalar introduced with the aim of avoiding multiple eigenvalues.

Apply the eigentransformation T to find Z_{d} and W_{d}

T(Cₜₗ⁻¹C_{bl})T⁻¹=W_{d} (42)

T(Cₜₗ⁻¹Cₜᵣ)T⁻¹=Z_{d} (43)

Since the same transformation is used to diagonalize both matrixes, wᵢ and zᵢ correspond to the same sinusoidal component. On the other hand, a necessary condition for this property to hold, is that all the matrixes involved in the two matrix pencils Jₜᵣ−μJₜₗ and J_{bl}−λJₜₗ can be written as the product of the same left and right matrixes, with possibly a different matrix in the middle. A sufficient condition for KLP and Q for Y′ and Z′ to have full rank is

P−L≧M K,L≧M Q−K≧M (44)

The relation (44) implies that if we set L=K=M, the sufficient condition for having a unique solution is P≧2M, Q≧2M. In other words we need to know G[m,n], 0≦m≦2M−1, 0≦m≦2N−1(in our case the G[m,n] are the Fourier series coefficients of g(x,y), therefore only O(M²) samples of g(x,y) yield a unique solution for the set {(wᵢ, zᵢ)}). Note that we assumed a deterministic signal, and as long as the condition (44) is satisfied, it is possible in this case to have a perfect reconstruction. However, in the case of noisy data, the schemes that use oversampling yield more accurate estimation.

Finally one last step is required to solve for the corresponding set of weights {aᵢ}, which can be done starting from the equation (32), i.e. A=W′⁺JZ′⁺, where (*)⁺ denotes a pseudoinverse of (*). Since both W′ and Z′ have rank M, the above system will have a unique solution for the matrix of coefficients A, thus the signal can be perfectly reconstructed.

An example of the above methods can be found in FIGS. 6a to 6d: FIG. 6a represents the original signal composed of 17 2-D Diracs, FIG. 6b represents a 2-D sinc smoothing kernel, FIG. 6c represents an approximation obtained by convolving the signal of FIG. 6a with the kernel of FIG. 6b and finally FIG. 6d shows the signal reconstructed according to one aspect of the invention.

In a further embodiment of the present invention, the reconstruction method of the invention is applied the case of signal modeled as “blurred” version of sets of Diracs, or more precisely as the convolution of the signal g(x,y) with a certain point spread function (PSF). This case is of particular interest to the fields of optical astronomy and videogrammetry, where the image formation without noise can be modeled as the convolution of the object containing a number of point sources (i.e. stars or sharp details) with the PSF, which may be a result of the imperfections of the imaging optics, atmospheric processes etc.

In particular the invention is used to extract the direction of a detail or a number of details from a digitized photographic image. The invention further allows obtaining the exact 3-D position of a number of details in a set of videogrammetry images.

FIG. 4a shows a scene containing a highly contrasted point-like detail 1. The scene is viewed by two identical cameras 10, each producing a 2-D projection of the scene on the respective image plane 15.

The above disposition has been chosen in this example for the sake of simplifying the explanation only. The invention includes as well methods and devices to treat the images coming from any number of dissimilar cameras. At the same time the scene to be analyzed does not limit itself to a single point-like source. On the contrary any scene containing a plurality of details can be analyzed by the methods and devices of the invention.

Ideally the point-like detail 1 should produce a 2-D Dirac pulse in the luminosity projected on the image plane 15. In this case it would be easy to determine the exact position of detail 1, by tracing the imaginary straight line 19 joining the image 18 and the centre of the objective 11, on which the detail 1 lays. The same is repeated for the second camera 20, and the two lines 19 and 29 define, with their unique intersection, the position of detail 1 in space.

In a real case the above procedure yields only an approximate result. The sharpness of the image 18 is in fact degraded by the optics 11, and the intensity on the image plane 15 will be described by a smooth distribution of finite width. It is usually admitted that the luminosity follows a Gaussian distribution,

$$h ( x , y ) ∝ exp ( - \frac{{x}^{2} + {y}^{2}}{2 {σ}^{2}} ) \qquad ( 45 )$$

defined by σ width a describing for example the resolution of the optical system 11. Other distribution could however be chosen, according to the circumstances, without leaving the scope of the claimed invention.

FIG. 4b shows the intensity distribution on the focal plane 15 and the distribution of the samples 50 obtained by a CCD or an equivalent image detector 12 placed on the image plane. The finite sampling operated by the CCD further reduces the information available, and limits the possibility of directly locate the position of the image 18. In this case, the method above can not provide an exact position of the detail 1, but rather an uncertainty region 100.

This situation can be improved, albeit never completely solved, by increasing the quality of the optics, reducing thus o; and adopting a CCD of higher resolution. Such solution implies however cameras of higher cost and size, which limits the applicability of this approach.

The light intensity coming from a finite number of point-like sources is approximated by a distribution of 2-D Dirac pulses, possessing, as discussed in the previous embodiments, a finite rate of innovation. The effect of the optical system 11 is to convolve the original function with a smoothing function h, in the example above a Gaussian kernel, while the CCD 12 performs a periodical sampling of the smoothed signal 18. We have already shown in the previous embodiments that this class of signals can be perfectly reconstructed, provided a sufficient number of samples are acquired. The reconstruction method of the invention is therefore applicable and allows exact determination of the directions 19, 29 of the detail 1, provided that the PSF function is known.

In the general case, given the analytic expression for the PSF, a new sampling kernel for the invention should be h′(x,y)*φ_{g}(x,y). The purpose of introducing the first term h′(x,y)is to deconvolve the blurred signal prior to sampling it with the sinc sampling kernel or the Gaussian sampling kernel, or another suitable kernel. Under the noise-free assumption, this step is sufficient to obtain the set of samples which can be expressed as a linear combination of exponentials, and from which the location and weights of the Diracs can be uniquely found. However, that is true only if a is relatively small, so that the term h′(x,y) does not blow up, otherwise the system becomes ill-conditioned.

According to the circumstances, the reconstruction can be performed directly on the 2-D data or after the application of the Radon transform, in order to reduce to one-dimensional subproblems, as in the previous embodiments.

If more cameras are available, as in videogrammetry applications, the exact position of an object in space can be inferred by searching the intersection of the direction lines 19, 29 thus reconstructed, as in FIG. 4a.

The invention is not limited to the reconstruction of point-like details, but also to reconstruction of generic shapes in front of a contrasting background, the shapes being in general approximable with a piecewise linear or piecewise polynomial boundary. The reconstruction proceeds, in this case, by applying the appropriate differentiated kernels ρ^{(R+1)} and φ⁽²⁾ introduced in the previous embodiments.

In another embodiment of the present invention, the classic videogrammetry problem of finding the location and/or the orientation of one or more cameras from images of known reference points is solved. The invention may be employed to determine the position of a landing plane, or of another vehicle from the image of known landscape points taken by cameras on the vehicle. Also the invention may be applied to find out the orientation of a space craft from an image of a star field taken by one or more onboard cameras. The invention may as well be applied to the problem of determining the course of a watercraft from the images of landscape point and/or known navigational aids.

In the general case we have C different cameras, and N distinguishable points visualized on each image, the position of M points being known.

As it is generally known, the position and orientations in space of each camera are described by 6 unknowns, whereas each point introduces 3 unknowns. One has therefore 3·(N−4)+6·C unknowns. The images provide 2NC point image coordinates, one can therefore build 2NC equation where the point image coordinates figure as given values. If the condition

2NC>3(N−M)+6C (46)

is satisfied, the system is determined or overdetermined and the camera locations and directions in space can be reconstructed.

In the case in which the locations of the N points are unknown, the problem may be solved in a relative reference system, wherein one of the points is placed in the origin.

FIG. 5 shows a 2-D example where one camera 120, having coordinates (X_{c},Z_{c}) takes one image 300 of two points 61 and 62 whose known coordinates are (Xₚ₁,Zₚ₁) and (Xₚ₂,Zₚ₂).

If we determine now the coordinates v₁₁ and v₁₂ of the points 301 and 302 corresponding, on the image 300, to the points 61 and 62, we have:

$$\{ \begin{matrix}{v}_{11} = f \frac{( {X}_{c} - {X}_{p1} ) + tg ψ ( {z}_{c} - {z}_{p1} )}{tg ψ ( {X}_{c} - {X}_{p1} ) - ( {z}_{c} - {z}_{p1} )} \\ {v}_{21} = f \frac{( {X}_{c} - {X}_{p2} ) + tg ψ ( {z}_{c} - {z}_{p2} )}{tg ψ ( {X}_{c} - {X}_{p2} ) - ( {z}_{c} - {z}_{p2} )}\end{matrix} \qquad ( 47 )$$

where f represents the known focal distance.

In the particular case in which the orientation ψ of the camera 120 is known and fixed, the system above becomes linear and admits one unique solution.

The geometrical formulation of the above problems of videogrammetry is of course known. Actual videogrammetry applications suffer however from the inherent sampling limitations of real image capturing devices, like CCD, and from the imperfections of the optic system, that necessarily introduce image blurring to some degree.

The application of the sampling and reconstruction methods of the present invention to the above problem, provides a “superresolution” image, and allows perfect reconstruction of the position of the requested details, much beyond the limits that would be imposed by CCD and optics limitations.

By applying the reconstruction method of the invention, the given values of the above problem can be determined with precision, provided that the PSF of the cameras are known. In this way the reconstruction can be done exactly, despite the finite resolution of the optics and of the CCD.

The choice of the particular geometry of the FIG. 2 was done only in order to exemplify the invention, and does not constitute a limiting feature of the invention.

In the two embodiments above, reference was made to the noiseless case and, under this hypothesis, exact reconstruction was obtained from a minimal number of samples. If however the signal has a noise component superimposed, an adequate approximation of the true signal will be obtained by oversampling.

The sampling and reconstruction methods can be performed by hardware and devices in the form of dedicated circuits or systems and/or by a computer including memories in which software or firmware for carrying out the above described methods are stored and/or executed. The invention relates also to a circuit, to a system and to a computer program for processing sets of values obtained by sampling a signal with the above described methods.

1. Method for sampling a first multidimensional signal (g(x,y)) having a finite rate of innovation (ρ),
said method comprising convoluting said first signal (g(x,y)) with a sampling kernel (φ) and using a regular sampling rate (1/Tₚ),
said sampling kernel and said sampling rate being chosen such that the sampled signal (pₙ(θ₀)) is a complete representation of said first signal (g(x,y)), allowing a perfect reconstruction of said first signal,
characterized in that
said sampling rate (1/Tₚ) is lower than the frequency given by the Shannon theorem, but greater than or equal to the rate of innovation (p) of said first signal (g(x,y)).

2. Sampling method according to the preceding claim, further comprising a preliminary step of deriving a second one-dimensional signal (R(p,θ₀)) from said first multidimensional signal (g(x,y)).

3. Sampling method according to claim 2, wherein said preliminary step of deriving said second one-dimensional signal (R(p,θ₀)) from a multidimensional signal (g(x,y)) is performed by projecting said multidimensional signal (g(x,y)) onto a one-dimensional line.

4. Sampling method according to claim 20, wherein said preliminary step of deriving said second one-dimensional signal (R(p,θ₀)) from a multidimensional signal (g(x,y)) is performed by smoothing and projecting said multidimensional signal (g(x,y)) onto a one-dimensional line.

5. Sampling method according to one of the claims 3 or 4, wherein said step of deriving said first signal (x(t), f(p)) from a multidimensional signal (g(x,y)) is performed by applying the Radon transform to the multidimensional signal (g(x,y)) or to a smoothed version of the multidimensional signal (g(x,y)).

6. Sampling method according to one of the claims 1 to 5, wherein said multidimensional signal (g(x,y)) comprises a number N of point-like features comprising the step of projecting said multidimensional signal (g(x,y)) onto at least N+1 one-dimensional lines, to obtain at least N+1 one-dimensional signals (R(p,θᵢ)).

7. Sampling method according to claim 6, further comprising the steps of:
determining indicia of the said number N of point-like features on each of the said N+1 one-dimensional signals (R(p,θᵢ));
determining a projecting line for each of said indicia;
Inferring the position of said point-like features of said multidimensional signal (g(x,y)) from the positions where N+1 projecting linecross.

8. Sampling method according to one of the claims 1 to 7, wherein said sampling kernel (φ) is a sinc function.

9. Sampling method according to one of the claims 1 to 7, wherein said sampling kernel (φ) is a Gaussian function.

10. Sampling method according to one of the claims 1 to 7, wherein said sampling kernel (φ) is a spline function.

11. Sampling method according to one of the claims 1 to 7, wherein said sampling kernel (φ) is a box function.

12. Sampling method according to one of the claims 1 to 7, wherein said sampling kernel (φ) is a hat function.

13. Sampling method according to one of the claims 1 to 12, wherein said first signal (g(x,y)) is a periodic stream of weighted Dirac pulses.

14. Sampling method according to one of the claims 1 to 12, wherein said multidimensional signal (g(x,y)) is a bi-level polygon.

15. Sampling method according to claim 15 wherein said sampling kernel ((p) is a second derivative sinc function.

16. Sampling method according to one of the claims 1 to 12, wherein said multidimensional signal (g(x,y)) is a bi-level polygon with piecewise polynomial boundary with M pieces of maximum degree R.

17. Sampling method according to one of claims 1 to 12, wherein said multidimensional signal (g(x,y)) is a bi-level signal with a piecewise polynomial boundary having M pieces.

18. Sampling method according to claim 16 or 17, wherein said sampling kernel (φ) is a (R+1)th derivative sinc function.

19. Method for faithfully reconstructing a first multi-dimensional signal (g(x,y)) from a set of samples (G[m,n]), wherein the class of said signal to reconstruct (g(x,y)) is known, wherein the bandwidth of said first multi-dimensional signal (g(x,y)) is higher than 1T, T being the sampling interval,
wherein the rate of innovation (ρ) of said faithful reconstructed signal is finite, characterized in that said method comprises the step of solving a structured linear system depending on said known class of signal.

20. Method according to claim 19, wherein said reconstruction method includes the application of singular value decomposition methods.

21. Method according to claim 19, wherein said reconstruction method includes the following steps:
finding 2K spectral values of said first signal (g(x,y)),
using an annihilating filter method for finding said first signal (g(x,y)) from said spectral values.

22. Method according to claim 19, wherein said first signal (g(x,y)) is a finite stream of weighted Dirac pulses, said reconstruction method including following steps:
finding the roots of an annihilating filter to find the position of said pulses, solving a linear system to find the weights of said pulses.

23. Method according to any of the preceding claims, wherein said first signal (g(x,y)) has a noise component superimposed, and said sampling interval (T,Tₚ) is adapted to obtain an approximation of said first signal (g(x,y)).

24. Method according to one of the claims 1-23, wherein said first multidimensional signal (g(x,y)) is an image of a scene containing at least one feature (1, 61, 62), and the exact position of said at least a feature in said image is obtained from said sampled signal (pₙ(θ₀))

25. Method according to claim 24 further comprising the steps of:
taking at least two images of said at least one feature (1), from at least two distinct known locations;
determining the position of said at least one feature (1) in said scene from said exact positions in said at least two images.

26. Method according to one of the claims 1-23, wherein said first multidimensional signal (g(x,y)) is at least one image of a scene containing at least one feature (61, 62) recorded with at least one image recording means (120) further comprising the steps of:
obtaining the exact position of said at least one feature (61, 62) in said at least one image;
determining the position of said at least one image recording means (120) from said exact positions in said at least one image.

27. Method according to one of the claims 1-23, wherein said first multidimensional signal (g(x,y)) is at least one image of a scene containing at (east one feature (61, 62) recorded with at least one image recording means (120) further comprising the steps of:
obtaining the exact position of said at least one feature (61, 62) in said at least one image;
determining the orientation of said at least one image recording means (120) from said exact positions in said at least one image.

28. Device comprising means operatively arranged to perform the method of one of the preceding claims.

29. Computer program product directly loadable into the internal memory of a digital processing system and comprising software code portions for performing the methods of one of the preceding claims when said product is run by said digital processing system.
